(19) United States
(12) Patent Application Publication
(10) Pub. No.: US 2019/0254256 A1
(43) Pub. Date: Aug. 22, 2019

(54) Equine Motion Tracking Assembly

(71) Applicant: Felipe Vallejo, Hollywood, FL (US)

(72) Inventor: Felipe Vallejo, Hollywood, FL (US)

(21) Appl. No.: 15/900,486

(22) Filed: Feb. 20, 2018

(51) Int. Cl. A01K 15/02; A63B 24/00; A01K 11/00

(52) U.S. Cl. CPC A01K 15/02; A63B 2024/0025; A01K 11/006; A63B 24/0021

(57) ABSTRACT

An equine motion tracking assembly for remotely monitoring horse training includes a plurality of sleeves that is each worn around an associated one of a horse's legs. A plurality of tracking units is provided and each of the tracking units is coupled to an associated one of the sleeves. Each of the tracking units tracks motion of the horse during training exercises. Additionally, each of the tracking units is in wireless communication with an extrinsic electronic device thereby facilitating the training exercises to be remotely monitored.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to tracking devices and more particularly pertains to a new tracking device for remotely monitoring horse training.

### BRIEF SUMMARY OF THE INVENTION

An embodiment of the disclosure meets the needs presented above by generally comprising a plurality of sleeves that is each worn around an associated one of a horse's legs. A plurality of tracking units is provided and each of the tracking units is coupled to an associated one of the sleeves. Each of the tracking units tracks motion of the horse during training exercises. Additionally, each of the tracking units is in wireless communication with an extrinsic electronic device thereby facilitating the training exercises to be remotely monitored.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of an equine motion tracking assembly according to an embodiment of the disclosure.

FIG. 2 is a perspective view of an extrinsic electronic device of an embodiment of the disclosure.

FIG. 3 is a back view of sleeve of an embodiment of the disclosure.

FIG. 4 is a front phantom view of an embodiment of the disclosure.

FIG. 5 is a perspective in-use view of an embodiment of the disclosure.

### DETAILED DESCRIPTION OF THE INVENTION

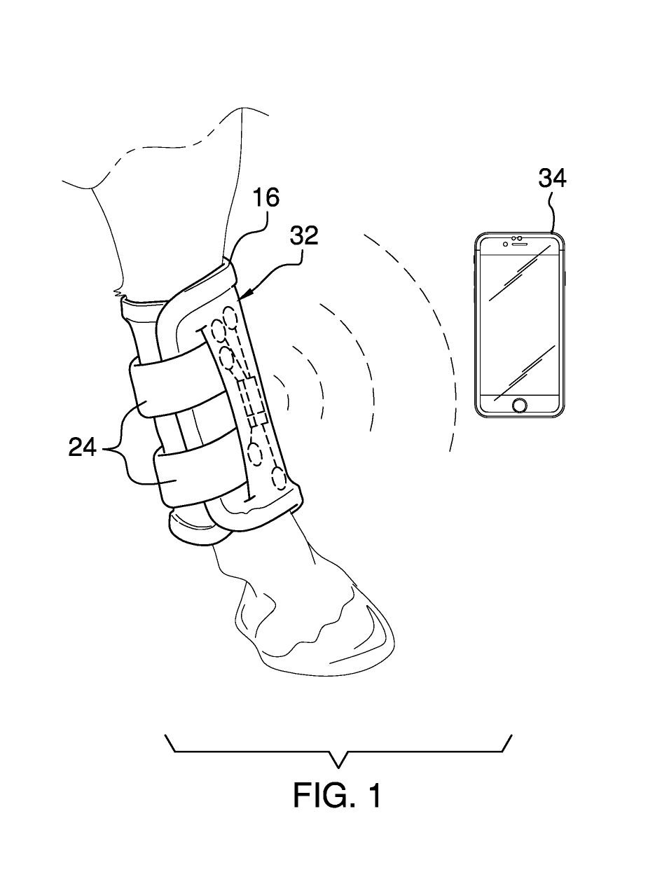

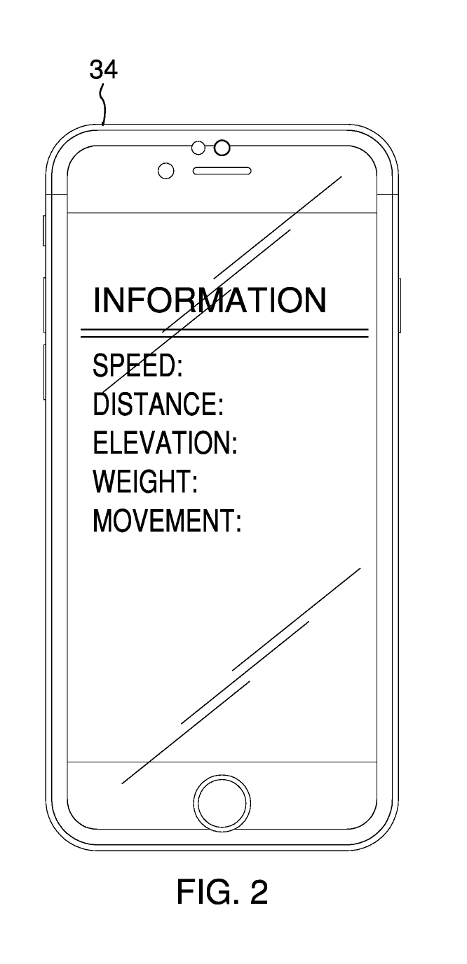

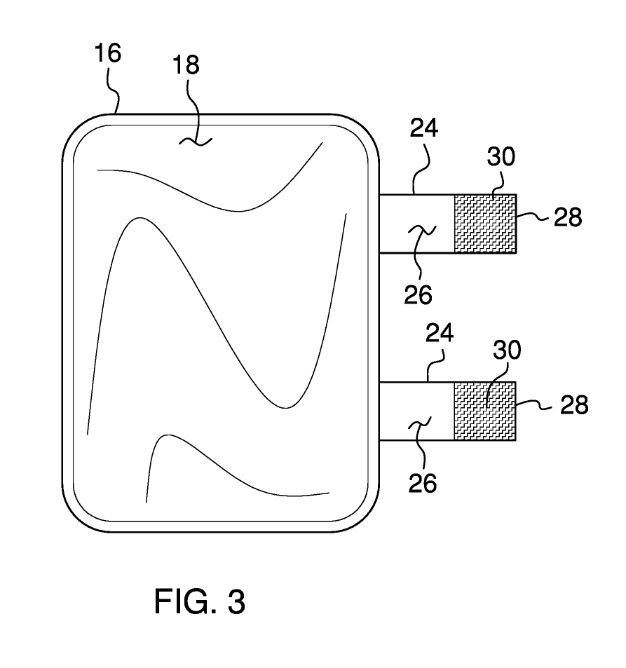

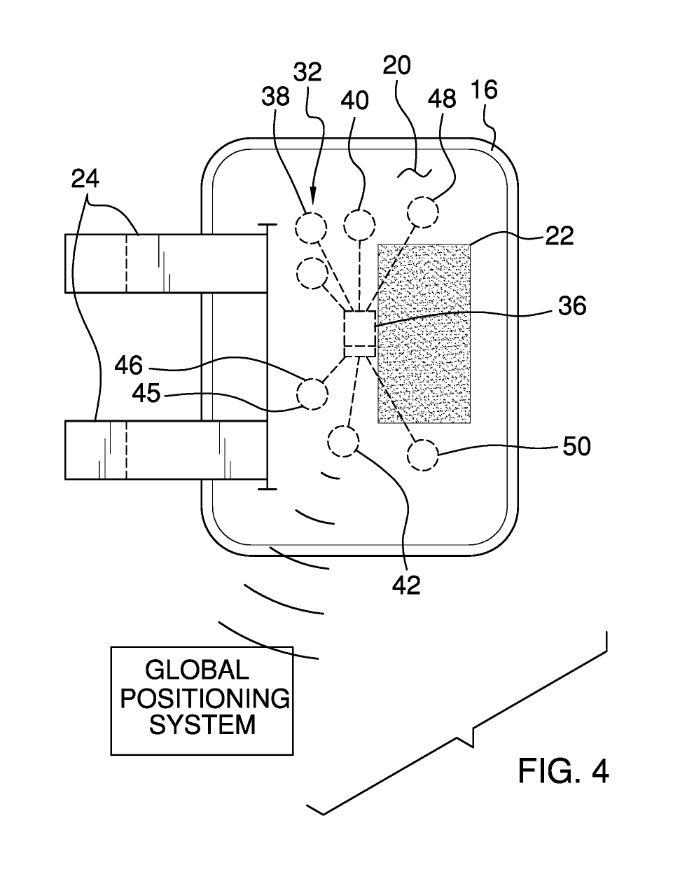

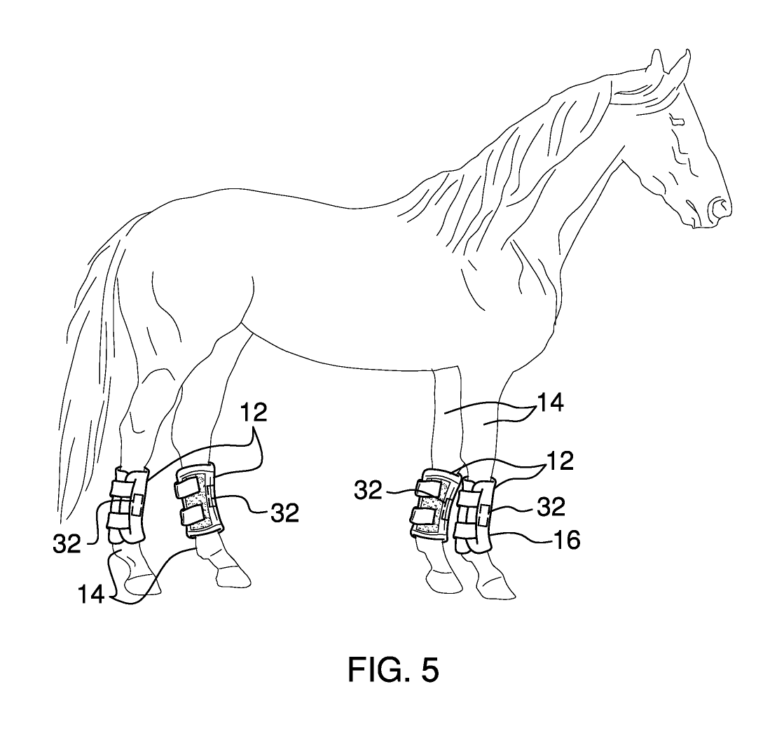

With reference now to the drawings, and in particular to FIGS. 1 through 5 thereof, a new tracking device embodying the principles and concepts of an embodiment of the disclosure and generally designated by the reference numeral 10 will be described.

As best illustrated in FIGS. 1 through 5, the equine motion tracking assembly 10 generally comprises a plurality of sleeves 12. Each of the sleeves 12 is worn around an associated one of a horse's legs 14 during training exercises. The horse may be a race horse, a dressage horse and any other horse being trained for competitive purposes. Each of the sleeves 12 comprises a panel 16 that has a first surface 18 and a second surface 20. The panel 16 is comprised of a deformable material and the panel 16 is wrapped around the horse's leg 14 having the first surface 18 of abutting the horse's leg 14.

A first mating member 22 is coupled to the second surface 20 of the panel 16 and a pair of straps 24 is each coupled to the second surface 20 of the panel 16. Each of the straps 24 has a bottom surface 26 and a distal end 28 with respect to the panel 16. Each of the straps 24 is wrapped around the horse's leg 14 to retain the panel 16 on the horse's leg 14. A pair of second mating members 30 is each coupled to the bottom surface 26 of an associated one of the straps 24 and each of the second mating members is aligned with the distal end 28 of the associated strap 24. Each of the second mating members 30 engages the first mating member 22 to tighten the straps 24 around the horse's leg 14. Additionally, each of the first 22 and second 30 mating members may comprise hook and loop fasteners or the like.

A plurality of tracking units 32 is provided and each of the tracking units 32 is coupled to an associated one of the sleeves 12. Each of the tracking units 32 tracks motion of the horse during training exercises. Additionally, each of the tracking units 32 is in wireless communication with an extrinsic electronic device 34. The extrinsic electronic device 34 may be a smart phone or the like that is carried by an individual that owns the horse. Thus, the owner of the horse may remotely monitor the horse's training exercises.

Each of the tracking units 32 comprises a processor 36 that is positioned within the panel 16. An elevation sensor 38 is positioned within the panel 16 to detect how high the horse's leg 14 is raised during walking, trotting and running. The elevation sensor 38 is electrically coupled to the processor 36 and the elevation sensor 38 may sense elevation through any electronic means. A weight sensor 40 is positioned within the panel 16 detect downward force exerted by the horse's leg 14 during walking, trotting and running. The weight sensor 40 is electrically coupled to the processor 36 and the weight sensor 40 may comprise an electronic accelerometer or the like.

A transceiver 42 is positioned within the panel 16 and the transceiver 42 is electrically coupled to the processor 36. The transceiver 42 is in wireless communication with a global positioning system 44. Thus, the processor 36 may determine a speed of the horse's leg 14 when the horse walks, trots and runs and a distance the horse has traveled during training exercises. The global positioning system 44 additionally facilitates the processor 36 to determine the speed of the horse when the horse walks, trots and runs. Additionally, the transceiver 42 is in electrical communication with the extrinsic electronic device 34. The transceiver 42 communicates data from the elevation sensor 38, the weight sensor 40 and the global positioning system to the extrinsic electronic device 34.

The transceiver 42 may be a radio frequency transceiver 42 or the like and the transceiver 42 may employ a WPAN signal and Bluetooth communication protocols. In this way the extrinsic electronic device 34 may be Synched via Bluetooth to the transceiver 42. Additionally, the transceiver 42 may communicate with the extrinsic electronic device 34 via the internet or a cellular phone network. A power supply 45 is positioned within the panel 16 and the power supply 45 is electrically coupled the processor 36. The power supply 45 comprises at least one battery 46.

A plurality of temperature sensors 48 is provided and each of the temperature sensors 48 is coupled to an associated one of the sleeves 12 to detect a temperature of the horse. Each of the temperature sensors 48 is electrically coupled to the processor 36 corresponding to the associated sleeve 12. Each of the temperature sensors 48 may be electronic temperature sensors of any conventional design. Additionally, a plurality of heart rate sensors 50 is provided and each of the heart rate sensors 50 is coupled to an associated one of the sleeves 12 to detect the horse's heart rate. Each of the heart rate sensors 50 is electrically coupled to the processor 36 corresponding to the associated sleeve 12 and each of the heart rate sensors 50 may be electronic heart rate sensors of any conventional design. The processor 36 may calculate the rate of calories being burned by the horse based upon data from the temperature sensor 48 and the heart rate sensor 50.

In use, each of the sleeves 12 is worn around the horse's legs 14 during training exercises. Each of the tracking units 32 records the motion of the horse and the horse's legs 14 during the training exercises. The transceiver 42 transmits the data from the tracking units 32 to the extrinsic electronic device 34. In this way the owner of the horse may remotely monitor the progress of the horse during the training exercises. The extrinsic electronic device 34 contains a program for aggregating and analyzing the data from the tracking units 32. In this way the owner can examine all aspects of the training exercises to include, but not be limited to, the speed at which the horse's legs 14 are moving, the direction the horse's legs 14 are moving, the overall speed of the horse from point A to point B, the height at which the horse's legs 14 are lifted during walking, trotting and running and the force generated by the horse's legs 14. Additionally, the horse's temperature and the horse's heart rate are continuously monitored and recorded by the extrinsic electronic device 34. The calories burned per hour by the horse as calculated by the processor 36 are additionally recorded by the extrinsic electronic device 34 for subsequent analysis.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An equine motion tracking assembly being configured to be worn on legs of horse during training thereby facilitating the training to be remotely monitored, said assembly comprising:
a plurality of sleeves, each of said sleeves being configured to be worn around an associated one of a horse's legs; and
a plurality of tracking units, each of said tracking units being coupled to an associated one of said sleeves wherein each of said tracking units is configured to track motion of the horse during training exercises, each of said tracking units being configured to be in wireless communication with an extrinsic electronic device thereby facilitating the training exercises to be remotely monitored.

2. The assembly according to claim 1, wherein each of said sleeves comprises a panel having a first surface and a second surface, said panel being comprised of a deformable material, said panel being configured to be wrapped around the horse's leg having said first surface of abutting the horse's leg.

3. The assembly according to claim 2, further comprising a first mating member being coupled to said second surface of said panel.

4. The assembly according to claim 3, further comprising a pair of straps, each of said straps being coupled to said second surface of said panel, each of said straps having a bottom surface, each of said straps being configured to be wrapped around the horse's leg to retain said panel on the horse's leg.

5. The assembly according to claim 4, further comprising a pair of second mating members, each of said second mating members being coupled to said bottom surface of an associated one of said straps, each of said second mating members engaging said first mating member to tighten said straps around the horse's leg.

6. The assembly according to claim 2, wherein each of said tracking units comprises a processor being positioned within said panel.

7. The assembly according to claim 6, further comprising an elevation sensor being positioned within said panel wherein said elevation sensor is configured to detect how high the horses leg is raised during walking, trotting and running, said elevation sensor being electrically coupled to said processor.

8. The assembly according to claim 7, further comprising a weight sensor being positioned within said panel wherein said weight sensor is configured to detect downward force exerted by the horses leg during walking, trotting and running, said weight sensor being electrically coupled to said processor.

9. The assembly according to claim 8, further comprising a transceiver being positioned within said panel, said transceiver being electrically coupled to said processor, said transceiver being in wireless communication with a global positioning system thereby facilitating said processor to determine a speed of the horse's leg when the horse walks, trots and runs and a distance the horse has traveled during training exercises, said transceiver being configured to be in electrical communication with the extrinsic electronic device such that said transceiver communicates data from said elevation sensor, said weight sensor and the global positioning system.

10. The assembly according to claim 6, further comprising a power supply being positioned within said panel, said power supply being electrically coupled said processor, said power supply comprising at least one battery.

11. An equine motion tracking assembly being configured to be worn on legs of horse during training thereby facilitating the training to be remotely monitored, said assembly comprising:
a plurality of sleeves, each of said sleeves being configured to be worn around an associated one of a horse's legs, each of said sleeves comprising:
a panel having a first surface and a second surface, said panel being comprised of a deformable material, said panel being configured to be wrapped around the horse's leg having said first surface of abutting the horses leg;
a first mating member being coupled to said second surface of said panel;
a pair of straps, each of said straps being coupled to said second surface of said panel, each of said straps having a bottom surface, each of said straps being configured to be wrapped around the horse's leg to retain said panel on the horse's leg; and
a pair of second mating members, each of said second mating members being coupled to said bottom surface of an associated one of said straps, each of said second mating members engaging said first mating member to tighten said straps around the horse's leg; and
a plurality of tracking units, each of said tracking units being coupled to an associated one of said sleeves wherein each of said tracking units is configured to track motion of the horse during training exercises, each of said tracking units being configured to be in wireless communication with an extrinsic electronic device thereby facilitating the training exercises to be remotely monitored, each of said tracking units comprising:
a processor being positioned within said panel;
an elevation sensor being positioned within said panel wherein said elevation sensor is configured to detect how high the horses leg is raised during walking, trotting and running, said elevation sensor being electrically coupled to said processor;
a weight sensor being positioned within said panel wherein said weight sensor is configured to detect downward force exerted by the horses leg during walking, trotting and running, said weight sensor being electrically coupled to said processor;
a transceiver being positioned within said panel, said transceiver being electrically coupled to said processor, said transceiver being in wireless communication with a global positioning system thereby facilitating said processor to determine a speed of the horse's leg when the horse walks, trots and runs and a distance the horse has traveled during training exercises, said transceiver being configured to be in electrical communication with the extrinsic electronic device such that said transceiver communicates data from said elevation sensor, said weight sensor and the global positioning system; and
a power supply being positioned within said panel, said power supply being electrically coupled said processor, said power supply comprising at least one battery.
